(19) United States
(12) Patent Application Publication
(10) Pub. No.: US 2012/0305601 A1
(43) Pub. Date: Dec. 6, 2012

(54) VIBRATING DEVICE

(76) Inventor: RAMI KHOURY SALAMA, Haifa (IL)

(21) Appl. No.: 13/150,569

(22) Filed: Jun. 1, 2011

(51) Int. Cl. A01C 15/02

(52) U.S. Cl. 222/196.1

(57) ABSTRACT

A vibrating device is provided that comprises body with a first chamber having a housing therein and a bottom open end and a base securable to the bottom open end. The vibrating device further comprises a serial electrical circuit that comprises a battery; an electric motor secured to the housing, the motor provided with a rotatable shaft having an eccentric weight mounted thereon; a bulb having walls made of low electric conductivity material; a first and a second electrical bulb wire, each extending through the walls with an end extending into the bulb, and at least one bead made of high electric conductivity material provided in the bulb. The bulb is configured so that when the device is tilted beyond a predetermined angle, the bead comes into simultaneous contact with the bulb wires, so that the motor and the battery are electrically engaged allowing the device to vibrate, and when the device is below the predetermined angle, the device does not vibrate.

### FIELD OF THE INVENTION

The present invention relates to electric vibrating devices.

### BACKGROUND OF THE INVENTION

There are numerous forms of dispensing devices for condiments such as salt, pepper, herbs and the like, which are provided with perforated caps, through which the contents are dispensed by inverting the dispenser and manually shaking it so that a portion of the contents drops out through the perforations, as required. However, it may be more convenient to dispense with a device that can mechanically dispense.

There are also to be found numerous forms of dispensing devices, such as for seeds and grain, which employ a form of electrically-induced vibration to dispense the contents.

U.S. Pat. No. 3,435,994 to Arnold Frede describes a vibrating dispenser having a lower chamber provided with a battery-driven motor having a rotatable shaft on which is mounted an eccentric weight. A support disk is disposed in the bottom chamber, the disk having an opening and an actuating pin is disposed therethrough and is freely vertically movable. The motor is on the disk. When the dispenser is lifted from the surface the pin is released and drops to close a circuit, whereupon the eccentric weight is caused to rotate on its shaft, creating a constant vibration for the dispenser. The vibration stops only when the dispenser is replaced on a flat surface.

Some disadvantages of the device described in U.S. Pat. No. 3,435,994 are that it is somewhat wasteful of the battery charge to have the motor operate in non-dispensing positions, which may also be annoying or cause the user to suspect something is wrong with the dispenser. The proper operation of the dispenser is also limited to use with a flat and hard surface for resting the dispenser, and the pin might catch on surfaces such as tablecloths and bags or disfunction due to dirt, lint etc accumulating on the pin, motor, electrical connections etc.

The invention aims to provide an improved vibrating device.

### SUMMARY OF THE INVENTION

It is provided in accordance with an embodiment of the present invention a vibrating device that comprises: a body comprising a first chamber having a housing therein and a bottom open end, a base securable to the bottom open end; a serial electrical circuit comprising: a battery; an electric motor secured to the housing, the motor provided with a rotatable shaft having an eccentric weight mounted thereon, and a bulb having: walls; a first and a second electrical bulb wire, each extending through a wall of the bulb and with an end extending into the bulb, and at least one bead in the bulb, the bead made of high electric conductivity material and the walls made of low electric conductivity material, wherein the bulb is configured so that when the device is tilted beyond a predetermined angle, the bead moves and comes into simultaneous contact with the bulb wires, whereby the motor and the battery are electrically engaged, allowing the device to vibrate, and when the device is below the predetermined angle, the device does not vibrate.

It is further provided in accordance with another preferred embodiment of the present invention, wherein the bulb is in the first chamber.

The device of claim 1, wherein the bead is selected from one of the group comprising: a mercury drop and at least one electrically conductive particle.

It is further provided in accordance with another preferred embodiment of the present invention, the body further comprising a second chamber having a top open end, and the device further comprising a perforated cap securable to the top open end.

It is further provided in accordance with another preferred embodiment of the present invention, the electrical circuit further comprises a switch configured to allow the device to be turned on and off by a user.

It is further provided in accordance with another preferred embodiment of the present invention, wherein the device is configured to be electrically chargeable.

It is further provided in accordance with another preferred embodiment of the present invention, wherein the device further comprises means for controlling the vibrations of the device.

It is further provided in accordance with another preferred embodiment of the present invention, configured to allow a user to predetermine the angle beyond which the device vibrates.

It is further provided in accordance with another preferred embodiment of the present invention, the electrical circuit further comprising means for warning a user that the perforated cap is not secured to the top open end.

It is further provided in accordance with another preferred embodiment of the present invention, wherein the device is configured to vibrate only if the perforated cap is secured to the top open end.

It is further provided in accordance with another preferred embodiment of the present invention, wherein the electric circuit further comprises: a first and a second electrically conductive bracket in electrical engagement with the battery; electrical wires connecting: the first bulb wire to the first bracket, the second bulb wire to the motor, and the second bracket to the motor, the housing comprising slots to hold the brackets and slots allowing at least one connect wire to pass therethrough.

It is further provided in accordance with another preferred embodiment of the present invention, wherein the device is impact-resistant.

It is further provided in accordance with another preferred embodiment of the present invention, wherein the body and base are made of impact-resistant material.

It is further provided in accordance with another preferred embodiment of the present invention, wherein the body, base and cap are made of impact-resistant material.

It is further provided in accordance with another preferred embodiment of the present invention, wherein the body has a roll-resistant shape.

It is further provided in accordance with another preferred embodiment of the present invention, wherein the device is capable of dispensing from within the second chamber and through the cap one or more of the condiments: salt, spices and herbs.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice.

In the accompanying drawings:

FIG. 1a shows a perspective view of a dispenser according to one embodiment;

FIG. 2 shows an exploded view of the dispenser shown in FIG. 1;

FIG. 3 shows a cross-sectional view of the dispenser taken on lines A-A;

FIG. 4 is an enlarged perspective view of an actuation bulb which may be placed inside the dispenser;

FIG. 5 illustrates in perspective view an interior of a chamber in the dispenser, which comprises fittings for the motor and wiring connected thereto;

FIG. 6 shows in perspective view an electromechanical unit, as it may be arranged in the dispenser, on top of a dispenser base;

FIG. 7 presents a perspective view of the base and electromechanical unit as in FIG. 6, together with fittings such as shown in FIG. 5, and

FIG. 8 is a schematic representation of an electrical circuit in some embodiments.

### DESCRIPTION OF THE PREFERRED EMBODIMENTS

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

The terms “comprises”, “comprising”, “includes”, “including”, and “having” together with their conjugates mean “including but not limited to”.

The term “consisting of” has the same meaning as “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

In discussion of the various figures described herein below, like numbers refer to like parts. The drawings are generally not to scale. For clarity, non-essential elements were omitted from some of the drawing.

According to one aspect, a vibrating device is provided, comprising: a body comprising a first chamber, the first chamber having a housing therein and a bottom open end; a base securable to the bottom open end; a serial electrical circuit comprising: a battery; an electric motor secured to the housing, the motor provided with a rotatable shaft having an eccentric weight mounted thereon, and a bulb having: walls; a first and a second electrical bulb wire, each extending through a wall of the bulb and with an end extending into the bulb, and at least one bead in the bulb, the bead made of high electric conductivity material and the walls made of low electric conductivity material, wherein the bulb is configured so that when the device is tilted beyond a predetermined angle, the bead moves and comes into simultaneous contact with the bulb wires, whereby the motor and the battery are electrically engaged, allowing the device to vibrate, and when the device is below the predetermined angle, the device does not vibrate.

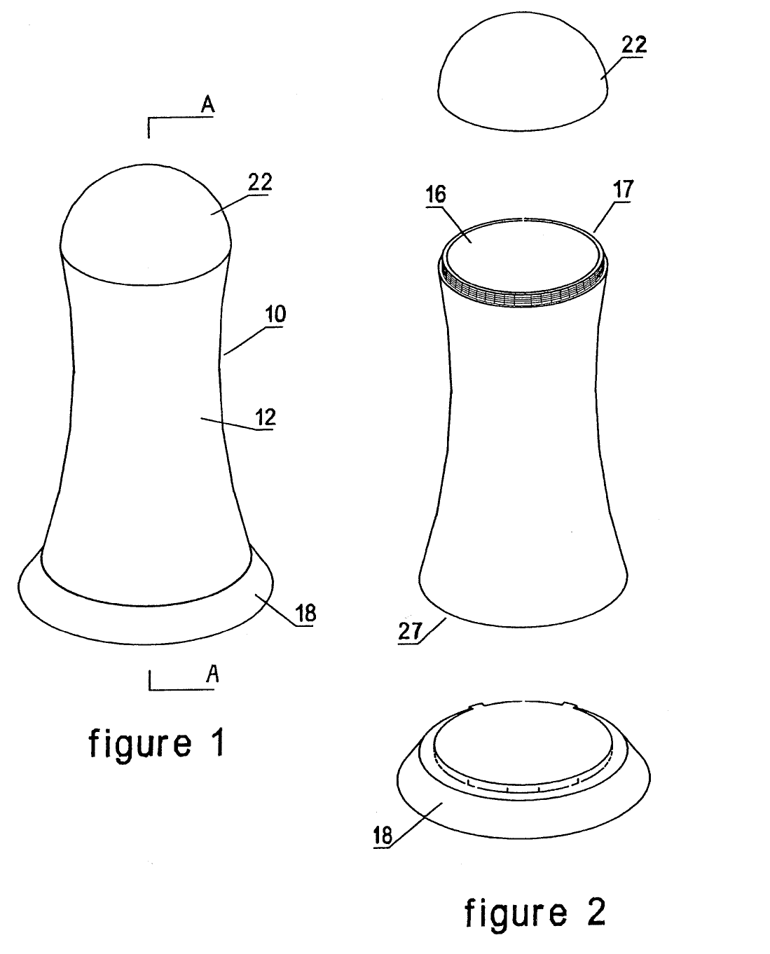

FIG. 1 shows an example embodiment, which is a salt or pepper dispenser 10, which to outward appearances looks like a regular manual dispenser.

FIG. 2 shows in exploded view the dispenser 10, showing a body 12 having a chamber 16 with a top open end 17, and the perforated cap 22 is securable to the top open end 17. The body 12 has another chamber, not shown, which is bordered by the bottom open end 27, securable with base 18.

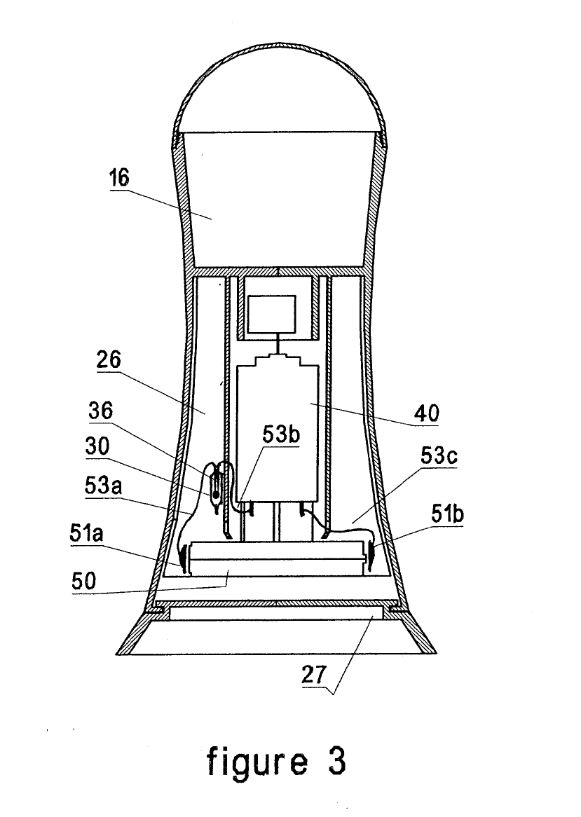

in FIG. 3, a cross-sectional view shows the chamber 26 (of body 12, and not visible in FIG. 2), bordered by the bottom open end 27, hereinbelow referred to as the first chamber.

Disposed within the first chamber 26 is the bulb 30, the motor 40, and battery 50. The chamber 16 bordered by the top open end 17 is hereinbelow referred to as the second chamber.

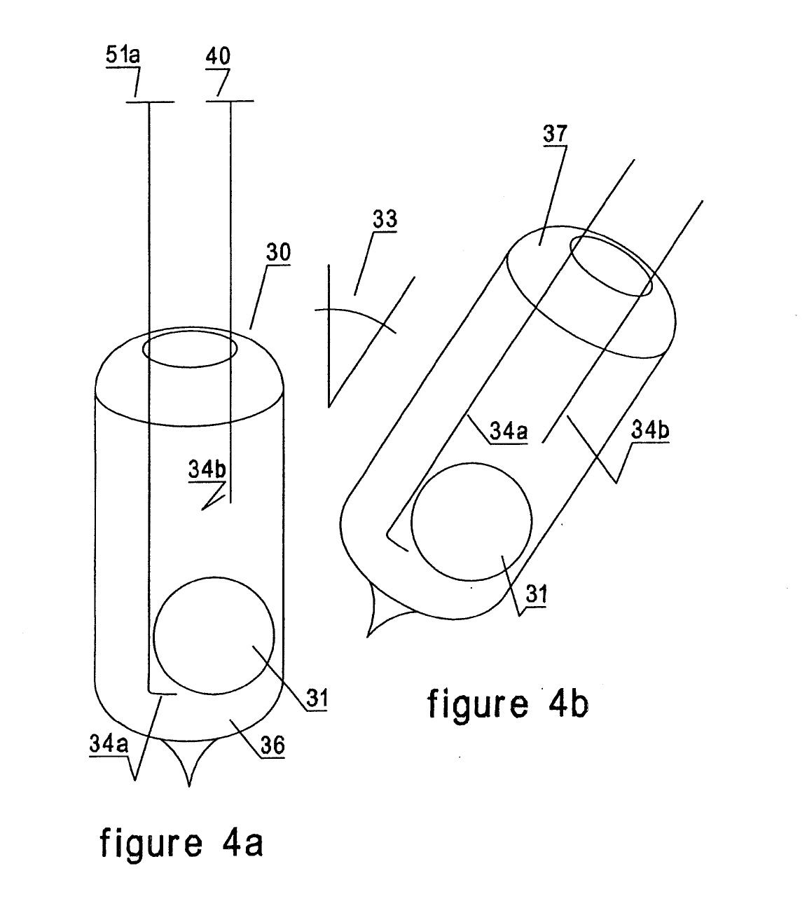

FIG. 4a shows in a greatly enlarged view the bulb 30. A drop of mercury 31 rests on the bottom of the interior space 36 of the bulb 30. Note the vertical and unfilled orientation of the bulb 30 in this figure and in FIG. 3. As the device 10 is tilted, the drop 31 is mobilized in the interior space 36, until at above a predetermined angle 33 it simultaneously contacts both first and second bulb wires 34a, 34b extending through a wall 37 of the bulb 30 and into the interior space 36, see FIG. 4b. Note that the bead/s are not required to be spherical, and may be cylindrical etc, of whatever shape and size that allows correct opening and closing the electrical circuit to activate and deactivate the motor 40 as the device 10 is tilted.

The bulb wires 34a and 34b may have different lengths in the bulb 30, as indeed shown in the figure, but in other embodiments may have similar or identical lengths. The length of the wires 34a, 34b and the dimensions of the bulb will affect the tilt angle at which the device is activated to vibrate.

Referring now to FIGS. 3 and 4 together, the electric circuit of the device 10 further comprises: electrically conductive brackets 51a, 51b connected to the battery 50; and connecting wires 53a-c connecting: the first wire 34a in the bulb 30 to a first bracket 51a, the second wire 34b in the bulb 30 to the motor 40, and the second bracket 51b to the motor 40, respectively.

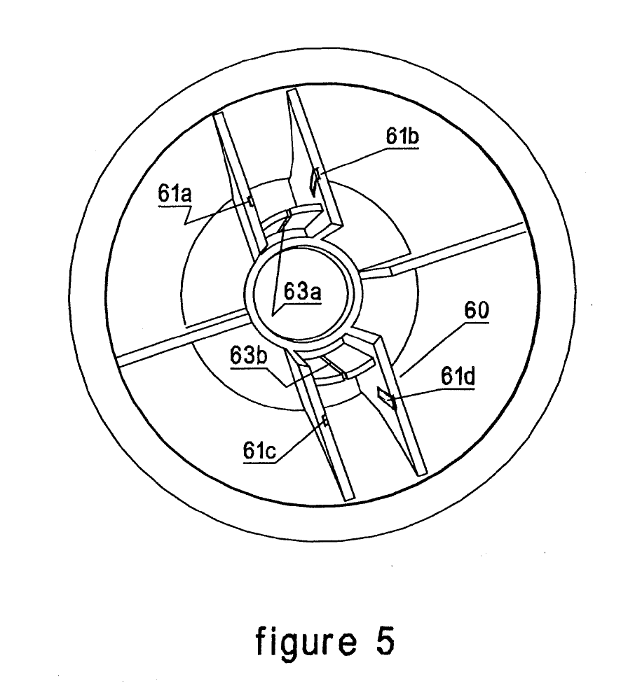

FIG. 5 depicts the housing 60 within the first chamber 26. The housing 60 comprises slots 61a-d to hold the brackets 51a, 51b, and slots 63a,63b allowing at least one wire 53a, 53b and/or 53c to pass therethrough. The housing 60 helps to keep the electrical circuit components in place. Although the bulb 30 may not be held by housing 60, the other parts of the circuit may hold it fairly in place.

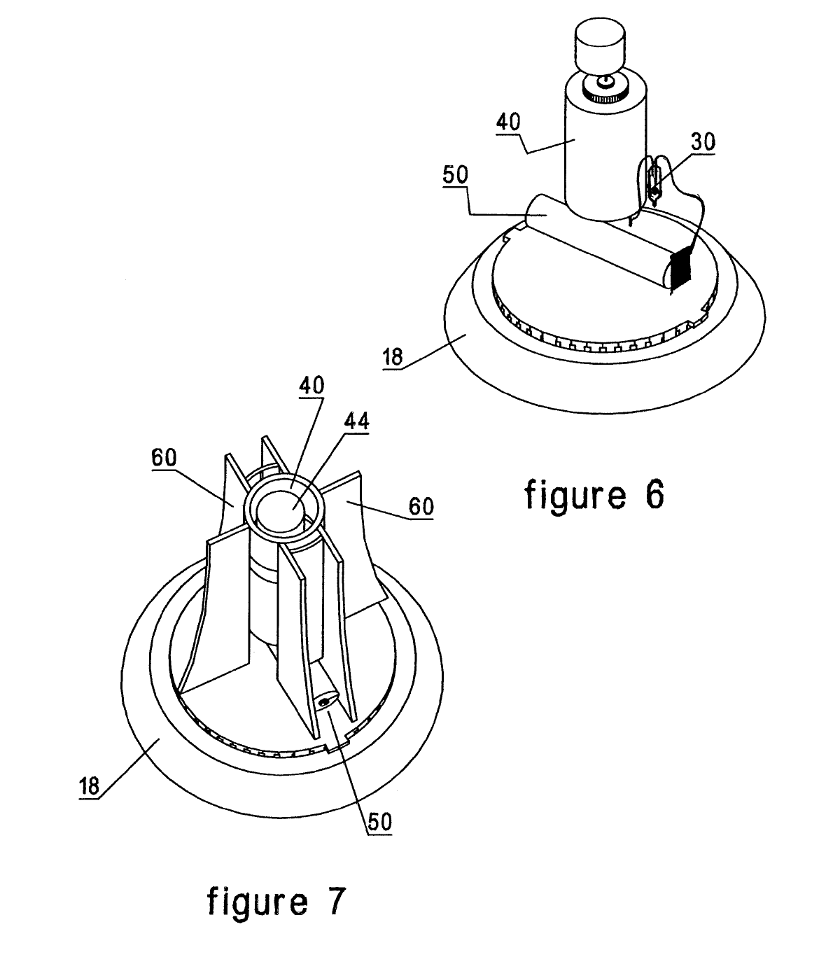

FIG. 6 shows the bulb 30, motor 40 and battery 50 over base 18 as they may be configured in the first chamber (the latter not shown for clarity).

FIG. 7 shows the motor 40 installed in the housing 60, the eccentric weight 44 showing. The motor 40 is secured by the housing 60, although the eccentric weight is freely rotatable.

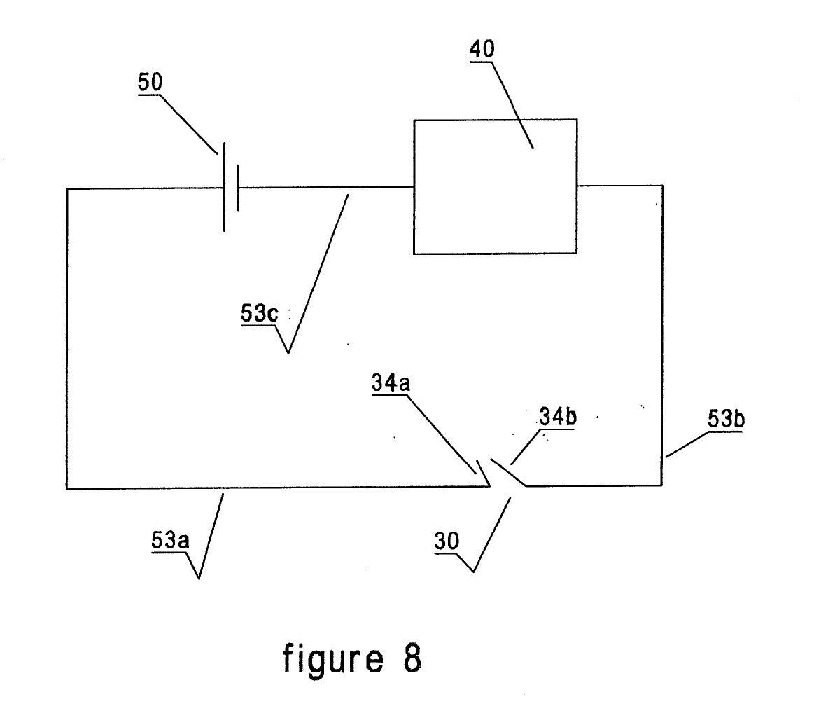

FIG. 8 is a schematic representation of an electrical circuit 80 in some embodiments.

In some embodiments (not shown) the bulb is not in the first chamber, for example it may be placed in an external alcove in the body, such that it can be manipulated by a user without need to access the first chamber. A user may thereby adjust the tilt angle at which the vibrating commences. This may be done simply by changing the position of the bulb relative to the body.

When the bead is a mercury drop 31, it is perhaps preferable to able to have the bulb 30 inside the first chamber 26, for safety reasons. Other beads such as one or more iron beads, or graphite powder, may be preferable to a mercury drop in some embodiments, such as ones with the more easily accessible bulbs.

In some embodiments (not shown), the electrical circuit further comprises a switch configured to allow the device to be turned on and off by a user, which may be handy when people such as babies are tempted to mishandle the device.

Some embodiments (not shown) may further comprise means such as sockets available to a user, that allow the battery of the device to be electrically chargeable.

In some embodiments (not shown), the device further comprises means for controlling the vibrations of the device, such as voltage controllers, alternative batteries and adjustable resistors as part of the electrical circuit. In a salt/spice dispenser, the vibration intensity or strength may determine heavy or light sprinkling of the salt/spice, according to the user's taste.

In some embodiments (not shown), the electrical circuit further comprises means for warning a user that the perforated cap is not secured to the top open end, for example in a salt shaker such means may save a user for inadvertently ruining a food preparation due to insecure fastening of the cap after filling with salt. For example, the cap and the top open end may simply have contacts leading by wires to adjoin the electrical circuit, such that a red light and/or sound alarm is turned on when the cap is improperly secured, and/or a green light is turned on when the cap is properly secured. Furthermore, the device may thus be set to vibrate only when the cap is secured to the top open end.

Preferably, the device is impact resistant, for example to help protect it from damage from inadvertently falling on the floor. Preferably, at least the body 12, base 18 and cap 22 are made of impact-resistant material. The housing 60 may also be made of impact-resistant material.

In some embodiments, the body has a roll-resistant shape to help preventing the device from falling and breaking.

The scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

I claim:

1 . A vibrating device comprising:
a body comprising:
a first chamber having a housing therein and a bottom open end;
a base securable to the bottom open end;
a serial electrical circuit comprising:
a battery;
an electric motor secured to the housing, the motor provided with a rotatable shaft having an eccentric weight mounted thereon,
a bulb having walls made of low electric conductivity material;
a first and a second electrical bulb wire, each extending through said walls with an end extending into the bulb, and
at least one bead made of high electric conductivity material provided in the bulb,
wherein the bulb is configured so that when the device is tilted beyond a predetermined angle, the bead comes into simultaneous contact with the bulb wires, so that the motor and the battery are electrically engaged, allowing the device to vibrate, and when the device is below the predetermined angle, the device does not vibrate.

2. The device of claim 1, wherein the bulb is in the first chamber.

3. The device of claim 1, wherein the bead is selected from one of the group comprising: a mercury drop and at least one electrically conductive particle.

4. The device of claim 1, the body further comprising a second chamber having a top open end, and the device further comprising a perforated cap securable to the top open end.

5. The device of claim 4, the electrical circuit further comprising means for warning a user that the perforated cap is not secured to the top open end.

6. The device of claim 4, wherein the device is configured to vibrate only if the perforated cap is secured to the top open end.

7. The device of claim 4, wherein the body, base and perforated cap are made of impact-resistant material.

8. The device of claim 4, wherein the device is capable of dispensing from within the second chamber and through the cap one or more of the condiments: salt, spices and herbs.

9. The device of claim 1, wherein the electrical circuit further comprises a switch configured to allow the device to be turned on and off by a user.

10. The device of claim 1, wherein the device is configured to be electrically chargeable.

11. The device of claim 1, wherein the device further comprises means for controlling the vibrations of the device.

12. The device of claim 1, configured to allow a user to predetermine the angle beyond which the device vibrates.

13. The device of claim 1, wherein the electric circuit further comprises:
a first and a second electrically conductive bracket in electrical engagement with the battery;
electrical wires connecting the first bulb wire to the first bracket, the second bulb wire to the motor, and the second bracket to the motor, the housing comprising slots to hold the brackets and slots allowing at least one connect wire to pass therethrough.

14. The device of claim 1, wherein the device is impact-resistant.

15. The device of claim 1, wherein the body and base are made of impact-resistant material.

16. The device of claim 1, wherein the body has a roll-resistant shape.
